(19) United States
(12) Patent Application Publication
(10) Pub. No.: US 2007/0072048 A1
(43) Pub. Date: Mar. 29, 2007

(54) Fuel cell

(76) Inventors: Takuya Hongo, Tokyo (JP); Yutaka Sata, Tokyo (JP); Eiichi Sakaue, Tokyo (JP); Yuusuke Sato, Tokyo (JP); Hirohisa Miyamoto, Kamakura-shi (JP); Norihiro Tomimatsu, Mitaka-shi (JP); Takahiro Suzuki, Tokyo (JP); Atsushi Sadamoto, Kawasaki-shi (JP); Masato Akita, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/387,881

(22) Filed: Mar. 24, 2006

(30) Foreign Application Priority Data
Sep. 29, 2005 (JP) 2005-284544

(51) Int. Cl. H01M 8/02

(52) U.S. Cl. 429/38

(57) ABSTRACT

A fuel cell includes a fuel electrode, an oxidant electrode, a fuel supply port, and a porous material layer for transferring a liquid fuel from the fuel supply port to the fuel electrode. The porous material layer has different values of at least one of a porosity, a permeability and a tortuosity factor depending on the distance of a site of the porous material layer from at least one of the fuel supply port and the fuel electrode.

### CROSS-REFERENCE TO RELATED APPLICATIONS

This application is based upon and claims the benefit of priority from prior Japanese Patent Application No. 2005-284544, filed Sep. 29, 2005, the entire contents of which are incorporated herein by reference.

### BACKGROUND OF THE INVENTION

1. Field of the Invention

The present invention relates to a fuel cell.

2. Description of the Related Art

In recent years, much attentions has been paid to a fuel cell as a clean power source that does not discharge harmful substances such as sulfur oxides and nitrogen oxides. Many small power source systems, for example, which are mounted to a vehicle, which are used as a domestic power source or which are mounted in a portable information equipment, are being proposed as the fuel cell system. Particularly, pure methanol or a mixture of methanol and water is used as the fuel in a direct methanol fuel cell (DMFC). Therefore, the fuel can be handled easily in the DMFC, compared with the fuel cell of the type that hydrogen is used as a fuel. In addition, a humidifying mechanism is not required in the DMFC and the operating temperature of the DMFC is low so as to make it possible to simplify the heat control mechanism. Because of these merits, the DMFC is adapted for use as a small fuel cell mounted in a small equipment.

Concerning the fuel supply methods for supplying a fuel to the DMFC, a liquid supply type and an internal evaporation type are excellent in view of the miniaturization of the system. Further, the liquid supply type can be classified into an active type and a passive type. In the active type, a liquid fuel is supplied into a fluid passageway plate by using auxiliary equipment such as a pump, and the liquid fuel is supplied from the fluid passageway plate onto a fuel electrode. On the other hand, in the passive type, the liquid fuel is supplied onto the fuel cell by utilizing mainly natural force such as gravity, capillary force and osmotic force. The DMFC is being used in various fields by utilizing the merits of these active type and passive type fuel supply systems.

In the type utilizing mainly natural force, the fuel can be supplied to the fuel cell without using auxiliary equipment such as a pump. Particularly, the type of transferring the liquid fuel by utilizing capillary force and osmotic force, i.e., the type that a porous material is used for forming the fuel passageway, makes it possible to supply the fuel with a high stability, compared with the type of utilizing gravity. This is also the case with the fuel cell applied to small portable equipment, in which the posture of the fuel cell is likely to be changed.

However, where a liquid fuel is supplied to the fuel electrodes of a plurality of fuel cells by utilizing capillary force and osmotic force alone of the porous material used in the prior art, it is necessary to make an additional effort to supply the fuel uniformly to the fuel electrodes. For example, it is necessary to make the distance between the fuel tank and the fuel electrodes as constant as possible.

A fuel cell in which the conventional porous material is used for supplying the fuel to the fuel electrodes is disclosed in, for example, Jpn. Pat. Appln. KOKAI No. 2003-297391. In the fuel cell disclosed in this prior art, unit cells are radially arranged around the liquid fuel guiding section in order to supply the fuel uniformly to the fuel electrodes. The fuel tank is arranged above the liquid fuel guiding section. The liquid fuel is supplied from the fuel tank into the fuel guiding section by capillary force or gravity and, then, the liquid fuel is supplied into the each of the unit cells.

Also, in the fuel cell disclosed in Jpn. Pat. Appln. KOKAI No. 2004-63200, an electrolyte layer is wound about the outer surface portion of a rod-like fuel electrode formed of a micro carbon porous material. The particular construction of the fuel cell is intended to supply uniformly the fuel to the fuel electrode.

In the DMFC, it is necessary to suppress the methanol crossover phenomenon. The methanol crossover phenomenon lowers an output or a fuel utilization efficiency. Therefore, it is necessary to supply the fuel to the fuel electrode at an optimum concentration, e.g., at a methanol concentration 3 M (molar ratio of methanol to water of 1:1) or less. It should be noted, however, that, if, for example, the methanol crossover phenomenon is not generated, methanol and water perform reactions theoretically at a molar ratio of 1:1, i.e., at about 17 M of the methanol concentration. Incidentally, 1 M denotes 1 mole/liter.

It follows that, in order to supply the fuel to the DMFC while suppressing the methanol crossover phenomenon, it is conceivable to supply the fuel of an optimum low concentration to the fuel electrode and to recover the residual fuel containing a large amount of water as disclosed in Jpn. Pat. Appln. KOKAI No. 2003-297391 and Jpn. Pat. Appln. KOKAI No. 2004-63200.

However, a problem that arises is that, in the fuel cell disclosed in Jpn. Pat. Appln. KOKAI No. 2003-297391 and Jpn. Pat. Appln. KOKAI No. 2004-63200, it is necessary to incorporate an extra residual fuel recovery mechanism and a holding mechanism of water, which is not required for the power generation, into the fuel cell. An additional problem that arises is that, in the construction disclosed in the prior art quoted above, the methanol concentration of the fuel supplied to the fuel electrode is lowered with increase in the distance of the fuel electrode from the fuel tank. In general, in the fuel cell using the conventional porous material, a fuel having a high methanol concentration is supplied to the area of the fuel electrode positioned close to the fuel tank, and the methanol concentration of the fuel supplied to the area of the fuel electrode remote from the fuel tank is lowered. If the methanol concentration of the fuel supplied to the fuel electrode is excessively high, the methanol crossover phenomenon is generated. On the other hand, if the methanol concentration of the fuel supplied to the fuel electrode is excessively low, the power generation tends to be made insufficient. Particularly, in the fuel cell of the type that a fluid passageway plate for supplying an aqueous solution of methanol to the fuel electrode is not included in the fuel cell and the fuel is supplied to the fuel electrode mainly by the osmotic force of the methanol aqueous solution generated in the porous material, the nonuniformity in the concentration of the methanol aqueous solution tends to be highly increased with increase in the distance of the fuel electrode from the fuel tank, compared with the fuel cell of the type of using a fluid passageway plate. Such being the situation, it is of high importance to develop the technology that permits optimizing the concentration of the methanol aqueous solution supplied to the fuel electrode regardless of the distance of the fuel electrode from the fuel tank.

Incidentally, Jpn. Pat. Appln. KOKAI No. 2002-110191 discloses an active type direct methanol fuel cell, comprising a fuel electrode provided with a diffusion layer in which the methanol permeability is increased toward the downstream side of the fuel in order to suppress the methanol crossover phenomenon in the former part of the fuel passageway and the shortage of the methanol supply in the latter part of the fuel passageway.

However, the methanol permeability is dependent on the thickness of the catalyst layer included in the fuel electrode and on the thickness of a solid polymer electrolyte membrane. Therefore, it is impossible to control the methanol permeability by simply controlling the properties alone of the diffusion layer. Such being the situation, it is very difficult to actually manufacture a diffusion layer having a desired methanol permeability. Further, since the fuel cell disclosed in Jpn. Pat. Appln. KOKAI No. 2002-110191 is of the type of including a fluid passageway plate that permits supplying the fuel having a relatively uniform concentration directly to the entire region of the diffusion layer, the diffusion layer is thinner than the porous material layer of the type of utilizing capillary force and osmotic force. Therefore, the methanol permeability can be controlled easily. However, since the porous material occupies a large ratio in the fuel cell of the type of utilizing the capillary force and the osmotic force of the porous material, it is very difficult to control the methanol permeability to fall within a desired range. It follows that it is impractical to control the methanol permeability as desired.

Jpn. Pat. Appln. KOKAI No. 2003-36866 discloses an active type liquid fuel cell, comprising a cathode-anode having a cathode-anode wicking structure including a cathode-anode wicking material capable of sucking and releasing water, the wicking structure being incorporated in or connected by the fluid connection to the anode-cathode, a liquid fuel passageway for supplying the liquid fuel to the anode, and a high concentration liquid fuel line for supplying a high concentration liquid fuel, which is mixed with water within the liquid fuel passageway so as to form an aqueous liquid fuel, to the liquid fuel passageway.

Jpn. Pat. Appln. KOKAI No. 2003-36866 teaches that the wicking material is compressed so as to determine the flow direction of the liquid fuel sucked by the wicking material such that the sucked liquid fuel flows from a part of the wicking material having a relatively small compression ratio to another part having a relatively high compression ratio. However, if the compression ratio is increased, the resistance exerted on the fuel is increased. It follows that, if a wicking material is used for the fuel supply, the nonuniformity of the fuel concentration may not be lowered, but may possibly be increased.

Jpn. Pat. Appln. KOHYO No. 11-511289 discloses an active type electrochemical fuel cell comprising an electrode substrate having grooves formed to extend in a direction perpendicular to the flow direction of the liquid fuel or having a penetrating planar nonuniform structure for controlling the transfer of the reactants and the reaction product.

The electrode substrate disclosed in the prior art quoted above acts as a cathode substrate or an anode substrate. When used as the cathode substrate, the electrode substrate removes water contained in the oxidant so as to make constant the oxidant concentration supplied to the cathode. On the other hand, when used as the anode substrate, the electrode substrate controls the transfer of methanol and carbon dioxide. It follows that the electrode substrate disclosed in the prior art quoted above is incapable of lowering the concentration gradient of the methanol aqueous solution.

Incidentally, Jpn. Pat. Appln. KOKAI No. 2001-6708 discloses an active type polymer electrolyte fuel cell, in which the water permeability of the region close to the gas introducing port in the gas diffusion layer on the cathode side is made lower than that of the other region in the gas diffusion layer on the cathode side in order to maintain a humidified state over the entire region of the solid polymer membrane even in the case of supplying a non-humidified oxidant gas (air). However, Jpn. Pat. Appln. KOKAI No. 2001-6708 quoted above does not refer to a porous material for supplying a fuel to the fuel electrode by utilizing mainly natural force.

### BRIEF SUMMARY OF THE INVENTION

An object of the present invention is to provide a fuel cell that permits a high output and a high fuel utilization efficiency.

According to an aspect of the present invention, there is provided a fuel cell, comprising:

a fuel electrode;

an oxidant electrode;

a fuel supply port; and

a porous material layer for transferring a liquid fuel from the fuel supply port to the fuel electrode;

wherein the porous material layer has different values of at least one of a porosity, a permeability and a tortuosity factor depending on the distance of a site of the porous material layer from at least one of the fuel supply port and the fuel electrode.

According to another aspect of the present invention, there is provided a fuel cell, comprising:

a fuel electrode;

an oxidant electrode;

a fuel supply port; and

first and second porous material layers for transferring a liquid fuel from the fuel supply port to the fuel electrode;

wherein:

the first porous material layer has different values of at least one of a porosity, a permeability and a tortuosity factor depending on the distance of a site of the first porous material layer from at least one of the fuel supply port and the fuel electrode; and

the second porous material layer is formed of a single porous material member.

Further, according to another aspect of the present invention, there is provided a fuel cell, comprising:

a fuel electrode;

an oxidant electrode;

a fuel supply port; and

first and second porous material layers for transferring a liquid fuel from the fuel supply port to the fuel electrode;

wherein:

the first porous material layer is formed of a single porous material member; and

the second porous material layer includes a plurality of porous material members, and the contact area of at least one of the porous material members with the first porous material layer is increased with increase in the distance of a site of the second porous material layer from the fuel supply port.

### BRIEF DESCRIPTION OF THE SEVERAL VIEWS OF THE DRAWING

FIG. 1 is an oblique view showing in a dismantled fashion the construction of a fuel cell according to a first embodiment of the present invention;

FIG. 2 schematically shows a porous material member for describing the tortuosity factor;

FIG. 3 is a cross-sectional view for conceptually explaining the first porous material layer included in the fuel cell shown in FIG. 1;

FIG. 4 schematically shows a porous material member having a fine tubular structure;

FIG. 5 is an oblique view showing in a dismantled fashion the construction of a fuel cell according to a second embodiment of the present invention;

FIG. 6A is a cross-sectional view for conceptually explaining the relationship between the thickness and the characteristics of the porous material members #01 and #02;

FIG. 6B is a cross-sectional view for conceptually explaining the relationship between the thickness and the characteristics of the porous material member #00;

FIG. 7 schematically shows a compressed porous material member;

FIG. 8 is an oblique view showing in a dismantled fashion the construction of a fuel cell according to a third embodiment of the present invention;

FIG. 9 is a plan view for explaining the composite used in the fuel cell shown in FIG. 8;

FIG. 10 is a cross-sectional view for conceptually explaining the composite;

FIG. 11 is an oblique view showing in a dismantled fashion the construction of a fuel cell according to a fourth embodiment of the present invention;

FIG. 12A is a side view for explaining the second porous material layer included in the fuel cell shown in FIG. 11;

FIG. 12B is a plan view for explaining the second porous material layer included in the fuel cell shown in FIG. 11;

FIG. 13 is a graph showing the relationship between the kind, the porosity and the permeability of the porous material member used in Example 1 of the present invention; and

FIG. 14 is a graph showing the relationship between the compression ratio, the porosity and the permeability.

### DETAILED DESCRIPTION OF THE INVENTION

The terms used in the present specification are defined as follows:

“Natural force” denotes the force for transferring a liquid fuel, which is generated in accordance with a law of nature. Natural force includes, for example, capillary force, osmotic force and gravity. Mechanical force such as a pumping pressure, which is generated by utilizing a law of nature, is not nature force.

“Capillary force” denotes the force for moving a liquid that is generated by the capillary phenomenon. In other words, capillary force denotes surface tension, i.e., the force derived from the differential energy between the liquid-solid interfacial energy and the gas-solid interfacial energy.

“Osmotic force” denotes the force with which a liquid material passes through a clearance of a solid material under the state that a gas-liquid interface is not present. For example, osmotic force denotes a fluid pressure for moving a liquid material within a porous material member under a wet state. Fluid pressure denotes, for example, an expanding vaporization force when a liquid material is gasified or a compression force for pushing a liquid material.

The embodiment of the present invention is directed to the fuel supply to a fuel cell using a mixture of at least two kinds of liquid materials as a fuel. Particularly, the embodiment of the present invention is directed to a fuel cell in which the fuel supply is carried out by utilizing the natural force acting on the liquid fuel within a porous material layer. However, the embodiment of the present invention does not exclude the use of pressure generated by auxiliary equipment such as a pump for assisting the natural force. Incidentally, a fluid passageway plate for supplying a liquid fuel to the fuel electrode is included in the fuel cell disclosed in each of Jpn. Pat. Appln. KOKAI No. 2002-110191, Jpn. Pat. Appln. KOKAI No. 2003-36866, Jpn. Pat. Appln. KOHYO No. 11-511289, and Jpn. Pat. Appln. KOKAI No. 2001-6708 referred to previously. In each of these conventional fuel cells, the residual fuel that is recovered is circulated via the fluid passageway plate so as to be reused. On the other hand, in the fuel cell according to the embodiment of the present invention, it is not absolutely necessary to use the fluid passageway plate for forming a circulating passageway of the residual fuel.

Some embodiments of the present invention will now be described with reference to the accompanying drawings.

### First Embodiment

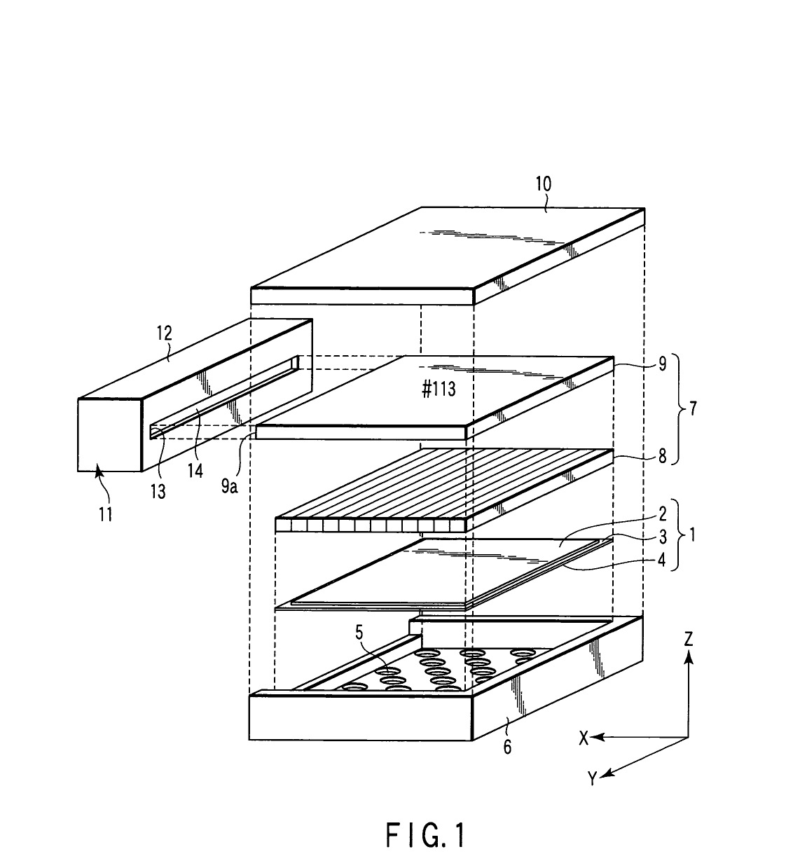

FIG. 1 is an oblique view showing the construction of a fuel cell according to the first embodiment of the present invention.

The fuel cell shown in FIG. 1 comprises a membrane-electrode assembly (MEA) 1 including a fuel electrode 2, a proton exchange membrane (PEM) 3 and an oxidant electrode 4, which are stacked one upon the other in the order mentioned. A liquid fuel such as a methanol aqueous solution is supplied to the fuel electrode 2, and the air containing oxygen, which is called an oxidant in the following description, is supplied to the oxidant electrode 4 so as to permit the MEA 1 to perform the power generation. Each of the fuel electrode 2 and the oxidant electrode 4 is constructed such that a catalyst layer is laminated on a diffusion layer (current collecting plate). The catalyst layer included in each of the fuel electrode 2 and the oxidant electrode 4 is positioned to face the PEM 3. The catalyst layer includes a supported catalyst in which catalyst particles such as Pr or Ru are supported by a support, a proton conductive substance and, as required, an electronic conductor. The diffusion layer is formed of, for example, a porous sheet. The porous sheet includes, for example, a carbon paper. The PEM 3 is formed of a fluorocarbon polymer having a cation exchange group such as a sulfonic group or a carboxylic group. It is possible to use, for example, Nafion (registered trademark of Du Pont Inc.) as the PEM 3.

The MEA 1 is housed in a frame 6 such that the oxidant electrode 4 is positioned to face an air intake hole 5 formed in the bottom portion of the frame 6. The oxygen-containing air (oxidant) is supplied from the outer air atmosphere to the oxidant electrode 4 through the air intake hole 5. It is possible to supply the air to the vicinity of the air intake hole 5 by using, for example, a fan while paying attention to the humidity of the oxidant electrode 4 and to the temperature of the fuel cell system. Since the oxidant having the oxygen concentration substantially equal to that of the air can be kept supplied to the oxidant electrode 4, it is possible to prevent the power generating capability of the MEA 1 from being lowered.

On the other hand, a porous material layer 7 is superposed on that surface of the MEA 1 which is not in contact with the air intake hole 5, i.e., superposed on the side of the fuel electrode 2. The porous material layer 7 permits a liquid fuel to be transferred from a fuel supply port 9a, which will be described herein later, to the fuel electrode 2 by utilizing natural force. The porous material layer 7 has different values of at least one of the porosity, the permeability and the tortuosity factor depending on the distance of a site of the porous material layer 7 from at least one of the fuel supply port 9a and the fuel electrode 2.

The porous material layer 7 has a double layer structure including of a first porous material layer 8 and a second porous material layer 9 stacked on the first porous material layer 8. The first porous material layer 8 is stacked directly on the fuel electrode 2 with no clearance provided therebetween, and the second porous material layer 9 is stacked directly on the first porous material layer 8. The first porous material layer 8 is constructed such that 12 kinds of porous material members #101 to #112 are sequentially arranged in the X-direction along the fuel electrode 2. On the other hand, the second porous material layer 9 is formed of a single porous material member #113.

As shown in FIG. 1, “X-direction” denotes a direction parallel to the flow direction of the liquid fuel flowing from a fuel supply port described herein later into the porous material layer. “Y-direction” denotes a direction perpendicular to the flow direction of the liquid fuel flowing from the fuel supply port into the porous material layer. Further, “Z-direction” denotes a thickness direction of the fuel electrode. In the present specification, the direction such that the distance from the fuel supply port is increase in the Z-direction is the downward direction. In other words, the direction toward the fuel electrode from the fuel supply port is the downward direction. On the other hand, the opposite direction to the downward direction is the upward direction.

Pressure is applied by a cover 10 to the porous material layer 7 and the MEA 1 so as to fix these porous material layer 7 and MEA 1 within the frame 6. In this case, one edge of the second porous material layer 9 is not covered with the frame 6 and the cover 10 so as to be exposed to the outside. The exposed one edge (exposed section 9a) is in contact with a fuel tank 11, and the exposed section 9a forms a fuel supply port of the fluid passageway formed of the porous material member. Incidentally, where it is impossible to discharge completely the CO₂ generated from the fuel electrode 2 to the outside in the construction described above, it is possible to form grooves on that surface of the first porous material layer 8 which is in contact with the fuel electrode 2. Also, it is necessary to arrange an external circuit in the vicinity of each of the fuel electrode 2 and the oxidant electrode 4 in order to take out the electric power generated from the MEA 1. The arranging site of the external circuit can be changed in accordance with the mechanism of discharging the CO₂ noted above. The CO₂ discharge mechanism and the external circuit are not shown in the drawing. Also, it is possible to omit the diffusion layer of the fuel electrode 2. In this case, the porous material layer 7 is laminated directly on the catalyst layer of the fuel electrode 2.

On the other hand, the fuel tank 11 comprises a container 12 provided with a slit 13. A porous material member 14 is attached to the inside of the container 12. The porous material member 14 is called an inside porous material layer herein later. The inside porous material member 14 is exposed to the outside via the slit 13. The inner region of the fuel tank 11 is filled with a methanol aqueous solution having a methanol concentration higher than the concentration required for the fuel electrode 2. The methanol aqueous solution filling the fuel tank 11 is called herein later a high concentration methanol aqueous solution.

The fuel tank 11 is connected to the frame 6 such that the exposed portion 9a of the second porous material layer 9, which is exposed from the frame 6, is brought into contact with the inside porous material member 14 exposed from the slit 13 of the fuel tank 11. It is desirable to connect the fuel tank 11 to the frame 6 such that the inside porous material member 14 exposed from the open portion of the fuel tank 11 and the second porous material layer 9 are not brought into contact with the outer atmosphere. By this particular construction, the high concentration methanol aqueous solution can be prevented from being evaporated to the outside. Also, it is desirable to control the amount of the high concentration methanol aqueous solution included in the fuel tank 11 so as to permit the methanol aqueous solution to be held within the porous material member and not to leak to the outside of the fuel cell. Particularly, in order to realize a fuel cell that can be turned upside down, it is desirable to control the amount of the high concentration methanol aqueous solution included in the fuel tank 11 so as to prevent the methanol aqueous solution from leaking to the outside no matter in which of X-, Y- and Z-directions gravity may be exerted. Likewise, it is desirable to construct the porous material layer 7 and the CO₂ discharge mechanism that is arranged as required in a manner to prevent the leakage of the methanol aqueous solution.

The porosity, the tortuosity factor and the permeability of the porous material member are taken up in the present invention as the parameters that should be changed. The reasons for the designation of these parameters are as follows.

The porosity ε and the tortuosity factor τ are the properties, which affect the diffusion coefficient of methanol or water, particularly, which control the concentration distribution.

The permeability K is the property, which denotes the flow resistance within the porous material member, particularly, which controls the pressure distribution.

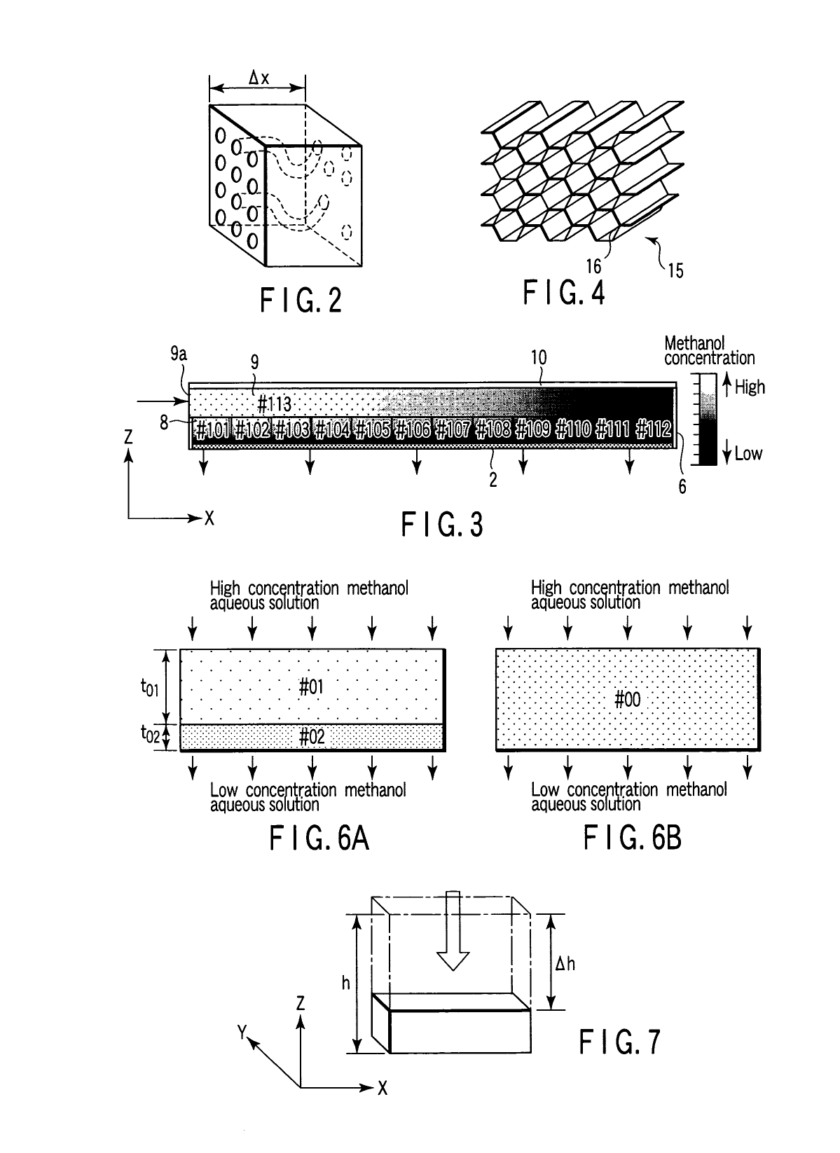

The tortuosity factor τ will now be described first with reference to FIG. 2.

The tortuosity factor τ is theoretically defined by formula (2) given below based on the length Δx shown in FIG. 2 and the length lₚ. The length lₚ denotes the length of the pore that is actually involved in the concentration diffusion within the length Δx.
τ=lₚ/Δx (2)

However, in actually obtaining the tortuosity factor τ, it is also necessary to consider the influence of the enlargement and shrinkage of the pore within the porous material member. Therefore, the tortuosity factor τ is obtained by procedures (i) to (iv) given below:

(i) To measure the diffusion coefficient D (m²/s) in the case where a porous material member does not exist.

(ii) To measure the diffusion coefficient D_{eff} (m²/s) in the case where a porous material member exists.

(iii) To calculate the porosity ε of the porous material member. The porosity ε is calculated by formula (3) given below:
ε=(Vₐ−V)/Vₐ (3)

where Vₐ denotes the apparent volume (m³) occupied by the porous material member, and V denotes the volume (m³) truly occupied by the porous material member.

(iv) To obtain the tortuosity factor τ by formula (4) given below in accordance with the Bruggeman formula:
τ=(log D_{eff}−log D)/log ε (4)

Within the porous material member, the porosity ε and the tortuosity factor τ control the diffusion coefficient of the concentration, and the diffusion coefficient is represented by formula (5) given below, i.e., Bruggeman formula:
D_{eff}=ε^{τ}D (5)

where D_{eff} denotes the diffusion coefficient within the porous material member, ε denotes the porosity, τ denotes the tortuosity factor (τ≧1), and D denotes the diffusion coefficient. As is apparent from formula (5), the diffusion coefficient D_{eff} of the porous material member can be enlarged in the case where the porosity ε is high or the tortuosity factor τ is low so as to facilitate the permeation of the liquid fuel within the porous material layer.

Also, the permeability K controls the pressure gradient of the liquid fuel within the porous material member, and the pressure gradient is represented by formula (6) given below, i.e., Darcy's formula:

$$∇ p = - \frac{μ}{K} u \qquad ( 6 )$$

where ∇p denotes the pressure gradient (Pa/m), μ denotes the viscosity coefficient of the liquid (Pa·s), K denotes the permeability (m²), and u denotes the apparent flow velocity (m/s) of the liquid. As is apparent from formula (6), the flow velocity of the fuel within the porous material member can be increased in the case where the permeability K is high.

In this embodiment, the simplest example will be taken up. In the simple example, each of the porous material members #101 to #112 has prescribed properties. These properties are constant within the single porous material member.

The porous material members #101 to #112 have properties differing from each other. To be more specific, the porous material members #101 to #112 differ from each other in at least one of the porosity, the tortuosity factor and the permeability in accordance with the region of the MEA 1 positioned right under the porous material members (#101 to #112). FIG. 3 is a cross-sectional view for conceptually explaining the first porous material layer shown in FIG. 1. In FIG. 3, the concentration of the liquid fuel (methanol concentration of the liquid fuel) permeating within the porous material member is denoted by the gradation of the monochromatic color. The dilute color portion of FIG. 3 denotes the region of a high methanol concentration, and the dark color portion of FIG. 3 denotes the region of a low methanol concentration. Also, the arrow in FIG. 3 notes the permeating direction of the liquid fuel.

The porous material members #101 to #112 are arranged along the fuel electrode 2. The porous material members #101 to #112 are arranged in the order of the values of the porosity ε and the permeability K of the porous material member such that the porous material member having small coefficients ε and K are positioned in the region close to the fuel supply port and that the farther from the fuel supply port in the direction X, the higher values of the coefficients ε and K of the porous material members. To be more specific, the porous material member #101 has the smallest porosity and the smallest permeability, and the porous material member #112 has the largest porosity and the largest permeability. In other words, the values of the porosity and the permeability of the porous material member are high in the case where the number # of the porous material member is large. In the second porous material layer 9, the liquid fuel permeating from the fuel supply port 9a into the porous material member #113 receives resistance within the porous material member #113. As a result, the methanol concentration is lowered with increase in the distance of the site of the porous material member #113 from the fuel supply port in the direction X so as to generate a concentration gradient. Then, the liquid fuel permeates from the second porous material layer 9 into the first porous material layer 8 so as to lower the concentration gradient because the first porous material layer 8 is constructed such that the permeability of the liquid fuel is increased with increase in the distance of the site of the first porous material layer 8 from the fuel supply port in the direction X. As a result, it is possible to lower the difference in concentration of the liquid fuel supplied to the fuel electrode 2 among different regions of the fuel electrode 2.

FIG. 3 is directed to an example of combining the porous material members #101 to #112 differing from each other in the values of the porosity ε and the permeability K. However, the present invention is not limited to this particular combination. For example, a similar effect can also be obtained in the case where the porous material members differing from each other in the value of only one of the porosity ε and the permeability K are arranged as described above. A similar effect can also be obtained in the case where the porous material members are arranged in the order of the value of the tortuosity factor τ such that, the farther from the fuel supply port in the direction X, the lower value of the tortuosity factor τ. The nonuniformity of the methanol concentration also generates in the thickness direction (direction Z) of the porous material layer. Therefore, the effect described above can also be obtained by using a laminate prepared by stacking the porous material members are arranged in the order the properties of the porous material member such that the value of the properties is differed from each other depending on the distance of the porous material member from the fuel supply port or from the fuel electrode in the thickness direction.

It follows that, it is possible to lower the nonuniformity in the concentration of the liquid fuel supplied to the fuel electrode 2, compared with the case where the porous material members #101 to #112 in the first porous material layer 8 are exactly the same in the value of any of the porosity, the tortuosity factor and the permeability, i.e., the case where the first porous material layer 8 is formed of a single porous material member. As a result, it is possible to realize a fuel cell having a high output and a high fuel utilization efficiency. Incidentally, the permeability that is irrelevant to the concentration is included in the parameters of the porous material member that should be controlled for lowering the difference in the concentration described above because the concentration distribution is also affected greatly by the fluidity.

As described above, a large feature of the first embodiment of the present invention resides in that the values of the porosity, the tortuosity factor or the permeability of the porous material members (#101 to #112) are varied in accordance with the distance between the fuel tank and a certain site of the fuel electrode. Because of this particular feature, it is possible to supply a methanol aqueous solution to any region of the fuel electrode under the state that the concentration of the methanol aqueous solution is kept as uniform as possible.

The methanol concentration of the high concentration methanol aqueous solution is determined in accordance with the ratio of the methanol to water in the methanol aqueous solution consumed by the fuel electrode. On the other hand, it is necessary to supply to the fuel electrode a methanol aqueous solution having a concentration lower than that of the high concentration methanol aqueous solution included in the fuel tank. In this case, even where the fuel electrode has regions differing from each other in the distance from the fuel tank, it is necessary to diminish the difference in concentration of the methanol aqueous solution supplied to the different regions of the fuel electrode. The porous material member through which flows the liquid fuel should be designed so as to minimize the difference in concentration as much as possible. In a fuel cell of this type, the particular design is highly important for obtaining a high output and a high fuel utilization efficiency.

Also, according to the first embodiment of the present invention, it is possible to suppress the difference in pressure in addition to the difference in concentration of the methanol aqueous solution supplied to different regions of the fuel electrode. This is another prominent feature of the first embodiment of the present invention.

If the pressure within the fuel electrode is nonuniform, the CO₂ bubbles present inside the fuel electrode are locally distributed nonuniformly. These bubbles tend to inhibit the supply of the methanol aqueous solution. In order to prevent the difficulty, it is necessary to make the pressure uniform. In other words, it is necessary to design the porous material member through which flows the liquid fuel in a manner to make the pressure as uniform as possible. In a fuel cell of this type, the particular design is highly important for obtaining a high output and a high fuel utilization efficiency.

It should also be noted that the output and the fuel utilization efficiency of the fuel cell can be improved without paying attention to the difference in concentration of the liquid fuel and to the difference in pressure if the porosity, the tortuosity factor and the permeability of the porous material members #101 to #112 are changed to conform with the regions of the fuel electrode in accordance with the distance of the porous material member from the fuel supply port.

The description given above is directed to an MEA whose output is changed depending on the methanol concentration.

On the other hand, it is also possible to improve the output and the fuel utilization efficiency of the fuel cell in the case of using the MEA that produces a prescribed output regardless of the methanol concentration. It should be noted in this connection that various phenomena during operation of the fuel cell, which is, for example, the CO₂ discharge, the contact between the MEA and the porous material member and the power collection via the porous material member, are affected by the porosity, the tortuosity factor and the permeability of the porous material member, though the influences to these phenomena may not be as large as the influences given to the fuel concentration distribution by the porosity, the tortuosity factor and the permeability of the porous material member.

FIG. 1 is directed to an example in which the first porous material layer capable of suppressing the nonuniformity of the methanol concentration is achieved by the combination of the 12 kinds of porous material members #101 to #112 differing from each other in properties. However, the first embodiment is not limited to the particular combination of the porous material members. It is possible to combine 2 to 11 kinds of porous material members or larger than 12 kinds of porous material members. The number of porous material members that are combined is determined based on the size and desired characteristics of the fuel cell. It is also possible for the first porous material layer to be formed of a single porous material member. As described above, at least one of the porosity, the permeability and the tortuosity factor of the porous material members is changed stepwise or consecutively with increase in the distance of the site of the porous material member from the fuel supply port in the X-direction or the Z-direction. Incidentally, it is possible for the porous material members #101 to #112 of the first porous material layer and the porous material member #113 for the second porous material layer to be formed of the same material or different materials.

The first embodiment is directed to an example in which the porous material layer is of a two-layer structure. However, the first embodiment is not limited to the particular example. The first embodiment can also be applied to a porous material layer that has three- or more-layer structure.

The porosity, the tortuosity factor and the permeability of each of the porous material members #101 to #113 can be determined by using a fluid calculation software available commercially, which permits calculation of the concentration of the porous material member. By determining the porosity, the tortuosity factor and the permeability of the porous material member appropriately, it is possible to lower the difference in concentration and the difference in pressure of the liquid fuel. The fluid calculation software noted above includes, for example, CFD-ACE+ V2004 by CFD Research Corporation and STAR-CD v3.2 by CD Adapco Japan.

It is desirable for the porous material layer 7 to be thicker than the diffusion layer of the fuel electrode. The thickness of the diffusion layer is generally about 0.6 mm. For example, it is desirable for the porous material layer 7 to have a thickness not smaller than 1 mm. If the thickness of the porous material layer 7 is excessively small, it is impossible in some cases to obtain the effect of making the methanol concentration uniform. On the other hand, the limit in the size of the porous material layer, i.e., the critical size, is indicated in some cases in the calculation referred to above. The critical value noted above restricts the upper limit in the thickness of the porous material layer. To be more specific, if the distance of the site of the porous material layer from the fuel supply port is excessive large, the methanol concentration tends to be made lower than the methanol concentration required for the power generation in the MEA. In other words, it is possible to generate a region to which a liquid fuel of a sufficient concentration is not supplied. It is desirable for the longest portion of the porous material layer to be shorter than the height to which the liquid fuel can be moved upward by the natural force generated within the porous material member. If this requirement is satisfied, it is possible to form a fuel cell that can be operated under any posture.

It suffices for the porous material member used in the porous material layer to have a porous structure having fine open cells. The porous material member used in the present invention includes, for example, a material having a three-dimensional mesh structure, a material having powder sintered structure and a material having a fine tubular structure. FIG. 4 schematically shows a porous material member having a fine tubular structure. A porous material member 15 shown in FIG. 4 has a honeycomb-shaped fine tubular structure. The porous material member having the fine tubular structure (having straight pores 16) can be defined to have a tortuosity factor τ of 1. Incidentally, the porous material member having bent open cells has a tortuosity factor τ exceeding 1.

To be more specific, the porous material member can be formed of, for example, a carbon-sintered material, a carbon paper, sponge and a ceramic material. The ceramic porous material includes, for example, a silicon carbide porous material. The silicon carbide porous material has open cells and is excellent in its resistance to chemicals, particularly, resistance to alcohols contained in the fuel. The silicon carbide porous material is described in detail, for example, in a non-patent document “Nature of porous material and application technology thereof” by Yasushi Takeuchi, Fuji Techno System, 1999, page 62. A plastic formed carbon (PFC) porous material is also included in the ceramic porous material. The PFC porous material is also excellent in its resistance to chemicals. In addition, it is possible to form open cells in or to control the tortuosity factor τ of the PFC porous material by controlling the particle size or the amount of the binder. Also, the PFC porous material can be processed and molded easily.

The carbon-sintered material can be manufactured by, for example, mixing carbon particles with a binder, followed by sintering the resultant mixture. In this case, the properties of the carbon-sintered material can be controlled by controlling the amount of the binder contained in the mixture. To be more specific, the porosity ε and the permeability K can be heightened by increasing the amount of the binder contained in the mixture. When it comes to sponge, the properties of the sponge can be controlled by controlling the amount of, for example, a foaming agent. In the case of a carbon paper, the properties of the carbon paper can be controlled by, for example, changing the fiber diameter of the carbon fiber that is used. Further, in the case of a ceramic porous material, it is possible to control the properties of the ceramic porous material by changing the particle size of the raw material particles and the sintering conditions.

Particularly, where the porous material member is formed of granular materials, it is possible to determine the grain size based on the porosity ε and the permeability K of the porous material member, which are determined by the calculating method described above. To be more specific, in this case, it is known in the art that the grain size is satisfied with formula (1) given below based on the porosity ε and the permeability K of the porous material member. In other words, the porosity ε and the permeability K of the porous material member can be controlled to fall within desired ranges by controlling the grain size of the granular material used in accordance with formula (1) given below:

$$d = C \times \sqrt{\frac{{K ( 1 - ɛ )}^{2}}{{ɛ}^{3}}} \qquad ( 1 )$$

where d denotes the grain size (m), K denotes the permeability (m²), ε denotes the porosity, and C denotes a proportional constant.

In this case, the proportional constant of Carman-Kozeny formula and the proportional constant of Blake-Kozeny formula are known well as the proportional constant. The values of these constants are deviated from each other by about 10%. Therefore, where the grain size is determined by using formula (1), it should be considered that the determined grain sizes based on these constants have about 10% of difference. In other words, the proportional constant C in formula (1) falls within a range of between the proportional constant of Carman-Kozeny formula and the proportional constant of Blake-Kozeny formula including the proportional constant of Carman-Kozeny formula and the proportional constant of Blake-Kozeny formula.

Also, in the fuel cell shown in FIG. 1, a reliable contact between the porous material members and between the diffusion layer of the fuel electrode 2 and the porous material member is one of the conditions required for allowing the diffusion layer of the fuel electrode 2 and the plural porous material members #101 to #113 to perform the function of a fuel passageway. For example, where the porous material members #101 to #112 are formed of a hard material that is unlikely to be deformed by the external force such as the fastening of a cover like a carbon sintered material, it is desirable for the porous material member #113 to be formed of a material such as a carbon paper or sponge, which can be readily deformed by the external force. Also, it is desirable in some cases to define not only the wettability of the porous material member with the liquid fuel but also the equivalent capillary tube diameter of the porous material member and the diffusion layer (i.e., the capillary tube diameter in the case where the open cells within the porous material member are regarded as the capillary tubes), as required. By defining the equivalent capillary tube diameter noted above, it is possible to permit the liquid fuel to permeate appropriately by the osmotic force into the inside porous material member 14 of the fuel tank 11, the porous material member #113, the porous material members #101 to #112, and the diffusion layer of the fuel electrode 2 in the order mentioned.

The fuel cell shown in FIG. 1 can be used singly or a plurality of fuel cells can be stacked one upon the other. In the case that a plurality of fuel cells are stacked one upon the other, it is possible to obtain a greater electromotive force. Also, FIG. 1 exemplifies a fuel cell having only one MEA incorporated therein. However, it is also possible for a plurality of MEA's to be incorporated in a fuel cell.

When the fuel cell shown in FIG. 1 is stopped operating, it is desirable to prevent the porous material member from being brought into contact with the outer atmosphere. It is also desirable to remove the pressure for pushing the cover 10 against the frame 6 or the pressure for pushing the fuel tank 11 against the porous material member #113. In this case, it is possible to suppress or eliminate the contact between the porous material layers 8 and 9 or the contact between the porous material layer 8 and the diffusion layer of the fuel electrode 2.

If the porous material member is left in contact with the outer atmosphere, it is possible for the liquid fuel contained in the porous material member or the MEA to be evaporated into the outer atmosphere. In this case, in restarting the operation of the fuel cell, an excess time is required before reaching the state of a steady operation of the fuel cell. Also, if the contact between the fuel tank and the porous material member is maintained under the state that the porous material member is not in contact with the MEA, it is possible for the porous material member to be filled with the high concentration methanol aqueous solution included in the fuel tank under the state of the high concentration. In this case, when the MEA is brought into contact with the porous material member in restarting the operation of the fuel cell, the power generating efficiency tends to be markedly lowered or the MEA may possibly collapse. Also, if the contact between the porous material member and the MEA is maintained under the state that the fuel tank is not in contact with the porous material member, it is possible for the liquid fuel within the porous material member to be consumed completely because of the crossover phenomenon. Further, where the MEA performs the function of bringing the water generated in the oxidant electrode back to the fuel electrode, it is possible for the fuel electrode to be filled with the water generated in the oxidant electrode by the crossover phenomenon. As a result, in restarting the operation of the fuel cell, excess time is spent before reaching the state of the steady operation of the fuel cell. Also, where the fuel tank, the porous material member and the MEA are left in contact with each other, the liquid fuel is consumed without being used for the power generation. It is possible for the liquid fuel to be consumed without being used for the power generation in other cases described above.

The description given above is directed to a direct methanol fuel cell. However, the fuel cell according to the first embodiment of the present invention is not limited to the fuel cell of the particular type. It is possible to apply the first embodiment of the present invention to all the fuel cells, in which a mixture of at least two kinds of liquid materials (e.g., a mixture of alcohols such as ethanol or propanol and water) is used as the fuel, a porous material member is used for forming the transfer passageway of the fuel, and the fuel is supplied under the state of a liquid material.

### Second Embodiment

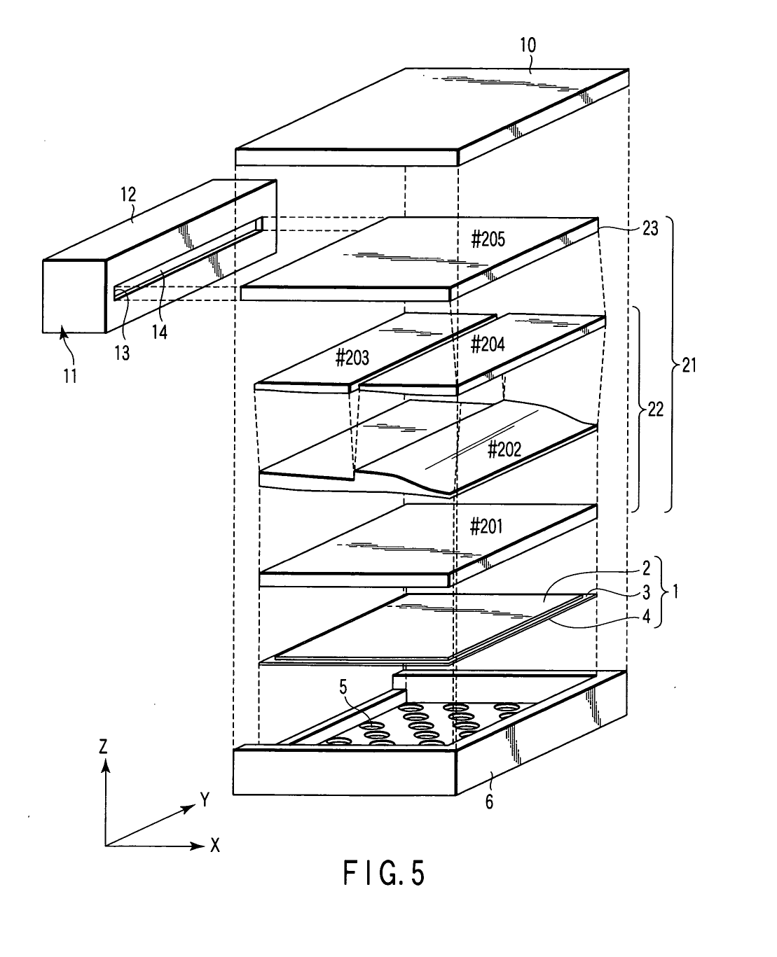

FIG. 5 is an oblique view showing in a dismantled fashion the construction of a fuel cell according to the second embodiment of the present invention.

The same reference numerals are put to the members or the portions, which operate the same functions of the fuel cells shown in FIGS. 1 and 5, for omitting the detailed description thereof.

As shown in the drawing, a porous material layer 21 is arranged on the surface of the MEA 1 on the side of the fuel electrode 2. The porous material layer 21 has a double-layer structure including of a first porous material layer 22 and a second porous material layer 23, which are stacked one upon the other in the Z-direction. The first porous material layer 22 is prepared by combining four kinds of porous material members #201 to #204, and the second porous material layer 23 is formed of a single porous material member #205. The porous material member #201 and the porous material member #202 are stacked in this order right above the fuel electrode 2. Further, the porous material member #203 and the porous material member #204 are stacked on the porous material member #202. Each of the porous material member #203 and the porous material member #204 has a width substantially half the width of the porous material member #202, and these porous material members #203 and #204 are arranged in direct contact with each other in the X-direction along the fuel electrode 2. Further, the porous material member #205 is arranged right above the porous material members #203 and #204. The fuel cell shown in FIG. 5 is equal in construction to the fuel cell shown in FIG. 1, except that the porous material layer 21 is constructed as described above. To be more specific, the fuel cell shown in FIG. 5 is equal in construction to the fuel cell shown in FIG. 1 in respect of, for example, the frame 6, the cover 10 and the fuel tank 11.

The porous material members #201 to #205 are featured as follows.

The porous material members #201 to #205 differ from each other in the porosity, the tortuosity factor and the permeability. The porous material members #201 to #205 also differ from each other in the stacking mode and thickness in accordance with the region of the fuel cell 2 positioned right below the porous material members #201 to #205.

Particularly, the porous material members #201, #203, #204 are substantially incapable of compression and the porous material member #202 can be compressed. Incidentally, the porous material member, which can be compressed, indicates a porous material member which of the dimension is changed by the pressure applied by the cover 10, in an amount larger than the planar dispersion. On the other hand, the porous material member, which is substantially incapable of compression, does not apply to the porous material member described above. The thickness of the porous material member #202 is controlled such that, when pressure is applied by the cover 10 to the porous material layer 21, the amount of compression is changed in accordance with the region of the MEA 1 positioned right below the porous material layer.

The porous material members #201 to #205 having the features described above produce the effect similar to that produced by the porous material members #101 to #113 used in the first embodiment. By combining the porous material members #201 to #205, it is possible to realize a fuel cell having a high output and a high fuel utilization efficiency, compared with the case where the porous material members #201 to #205 are equal to each other in any of the porosity, tortuosity factor and the permeability.

The effectiveness of the second embodiment will now be described.

As already described, it is possible to lower the difference in concentration and the difference in pressure of the liquid fuel supplied to the fuel electrode by controlling the porosity, the permeability and, as required, the tortuosity factor of the porous material member. However, the ranges within which the porosity, the tortuosity factor and the permeability of the porous material member can be controlled are limited depending on the kind of the porous material member. Therefore, it is impossible in some cases to obtain desired porosity, tortuosity factor and permeability in the case of using only one kind of the porous material member. Also, the kinds of the porous material members that can be combined are further limited depending on the contact compatibility when the first and second porous material layers are stacked one upon the other. It follows that the ranges within which the porosity, the tortuosity factor and the permeability of the porous material member are changed are further limited.

Under the circumstances, three measures given below are introduced into the second embodiment as a method for changing the porosity, the tortuosity factor and the permeability of the porous material member in addition to the measures taken in the first embodiment.

(I) In the first measure, a plurality of different kinds of porous material members are stacked one upon the other so as to change the thickness of each of the porous material member in accordance with the region of the fuel electrode. By this method, it is possible to change the porosity, the tortuosity factor and the permeability of the porous material layer in accordance with the region of the fuel electrode.

FIG. 6 is a cross sectional view conceptually showing the relationship between the thickness and the properties of the porous material member. FIG. 6A shows a laminate prepared by stacking porous material members #01 and #02 differing from each other in the porosity ε and the thickness t in a thickness direction (Z-direction shown in FIG. 5). As shown in the drawing, the porous material member #01 is stacked on the porous material member #02. The arrows in FIG. 6 denote the permeating direction of the liquid fuel. Where the porous material member #01 has a porosity ε₀₁ and the porous material member #02 has a porosity ε₀₂ (ε₀₂>ε₀₁), the laminate shown in FIG. 6A can be regarded as a porous material layer formed of a single porous material member #00 having a porosity ε′ as shown in FIG. 6B. The porosity ε′ is intermediate between the porosity ε₀₁ and the porosity ε₀₂.

To be more specific, if the porous material member #01 (porosity of ε₀₁) is assumed to have a thickness t₀₁ and the porous material member #02 (porosity of ε₀₂) is assumed to have a thickness t₀₂, the apparent porosity ε′ can be calculated as explained in items (i) to (iii) below:

(i) In the first step, the fuel concentration in the case of FIG. 6A is calculated under prescribed operating conditions of the fuel cell by using the fluid calculation software referred to previously. For example, calculated is the concentration of the methanol aqueous solution (low concentration methanol aqueous solution shown in FIG. 6) that is supplied to the MEA (not shown) positioned below the porous material member #02 in the case where a high concentration methanol aqueous solution is supplied from above the porous material member #01 shown in FIG. 6A.

(ii) In the next step, calculated is the fuel concentration in the case of FIG. 6B under the fuel cell operating conditions equal to those for item (i) given above on the assumption that the porous material member #00 has a certain porosity. For example, calculated is the concentration of the methanol aqueous solution (low concentration methanol aqueous solution shown in FIG. 6) supplied to the MEA (not shown) positioned below the porous material member #00, covering the case where the high concentration methanol aqueous solution is supplied from above the porous material member #00 shown in FIG. 6B.

(iii) Further, the results of the calculations for items (i) and (ii) are compared in order to examine whether the results of the calculations are equal to each other. For example, it is examined whether the concentration of the low concentration methanol aqueous solution supplied to the MEA, which is calculated in item (i), is equal to the concentration of the low concentration methanol aqueous solution supplied to the MEA, which is calculated in item (ii). If the concentrations thus calculated are not equal to each other, the calculation is performed again as in item (ii) by assuming again the porosity at a different value. If the calculated concentrations are equal to each other, the porosity of the porous material member #00 assumed in item (ii) provides the apparent porosity ε′ that should be obtained.

The porosity ε′ can be controlled by changing the ratio in thickness of the porous material member #01 to the porous material member #02. For example, the value of the apparent porosity ε′ can be heightened by increasing the ratio in thickness of the porous material member #02 so as to facilitate the permeation of the liquid fuel. As described previously, the concentration diffusion coefficient is dependent on the porosity of the porous material member. To be more specific, this measure utilizes the effect that, when it comes to the high concentration methanol aqueous solution, the decreasing rate of the concentration is dependent on the porosity of the porous material member. This is also the case with the tortuosity factor and the permeability in addition to the porosity.

The particular measure is applied to the porous material members #201 to #204 in FIG. 5. The thickness of the porous material member is changed in accordance with the region of the fuel electrode positioned below the porous material member. Particularly, in this case, the thickness of the porous material member is changed in accordance with the distance of the site of the porous material member from the fuel supply port. For example, a porous material member having the largest porosity is used for forming the porous material member #201, and the value of the porosity is gradually lowered in the porous material members #202 and 204 in this order. The porous material member #203 positioned close to the fuel supply port has the smallest porosity. It is possible to obtain desired properties by setting the porous material members such that the thickness ratio of the porous material member having a large porosity is increased with increase in the distance from the fuel supply port in the X-direction.

(II) In the second measure, a plurality of different kinds of porous material members are stacked one upon the other. The manner of stacking these porous material members is changed in accordance with the region of the fuel electrode. As a result, it is possible to control the values of the porosity, the tortuosity factor and the permeability in accordance with the region of the fuel electrode.

In the construction shown in, for example, FIG. 5, the porous material members positioned right above the porous material member #202 are divided into two kinds, i.e., divided into the porous material member #203 and porous material member #204. The porous material member #203 and porous material member #204 are arranged in accordance with the regions of the fuel electrode positioned below these porous material members. Particularly, in this case, the porous material member #203 and porous material member #204 are arranged in view of the distance from the fuel supply port. According to this measure, in the case where the combination of the porous material member #202 and the porous material member #203 is insufficient for realizing the desired porosity, tortuosity factor and permeability, it is possible to realize the desired porosity, tortuosity factor and permeability by the combination of the porous material member #202 and the porous material member #204 in addition to the porous material member #203.

The second measure can be applied to the case of using a porous material member having a prescribed thickness (e.g., membrane available commercially). For example, it is possible to combine a plurality of different kinds of porous material members differing from each other in properties or to combine a plurality of porous material members of the same kind. As a result, it is possible to produce the effect that the thickness of the porous material member seems to have been changed freely. In this measure, it is possible to obtain the effect similar to that produced by the first measure.

(III) In the third measure, a porous material member capable of compression is used as the porous material member. The manner of compressing the porous material member is changed in accordance with the region of the fuel electrode. As a result, it is possible to change the values of the porosity, the tortuosity factor and the permeability of the porous material member in accordance with the region of the fuel electrode.

FIG. 7 is a schematic drawing for explaining the compressed porous material member. As shown in FIG. 7, if a porous material member having a thickness h is compressed by Δh in the Z-direction, the values of the permeability K and the porosity ε of the porous material member are lowered. Particularly, where the compression rate is low, the permeability K can be markedly changed by compressing the porous material member. The porosity ε can also be changed by compressing the porous material member. In the case of the porosity ε, the amount of change is smaller than that of the permeability K. Further, when it comes to a porous material member that permits increasing the compression rate, the tortuosity factor τ can also be controlled as well as the porosity ε and the permeability K by simply compressing the porous material member. If the situation described above is utilized, it is possible to change the values of the porosity, the tortuosity factor and the permeability of the porous material layer by simply compressing a single kind of the porous material member.

The particular measure is applied to the porous material member #202 shown in FIG. 5. The thickness of the porous material member #202 before the compression is changed in accordance with the region of the fuel electrode 2 positioned below the porous material member #202. Particularly, in this case, the thickness of the porous material member #202 before compression is changed in accordance with the distance from the fuel supply port. The porous material member #202 is arranged on the porous material member #201. Also, pressure is applied to these porous material members #201 to #205 by using the cover 10. As a result, it is possible to change the compression amount of the porous material member #202 in accordance with the region of the fuel electrode 2.

It should be noted that, if the porous material member #202 is compressed, the permeability of the porous material member #202 is greatly changed. On the other hand, the amount of change of the porosity ε is smaller than that of the permeability K. In designing the porous material members #201 to #204, utilization of measures (I) to (III) given above should be considered while utilizing the situation described above.

To be more specific, it is possible to control mainly the apparent porosity ε′ of the first porous material layer 22 by combining the different kinds of porous material members #201, #203, and #204 each having a varied thickness. Further, the porous material member #202 having a varied thickness is combined, and the compression rate of the porous material member #202 is changed. As a result, it is possible to control mainly an apparent permeability K′ of the first porous material layer 22. The burden given to the designer can be lessened by the particular combination, compared with the case of not utilizing the nature obtained by compressing the porous material member. Further, the limitation by the kind of the porous material member that can be utilized can be markedly moderated, which is one of the effects obtained by the second embodiment of the present invention.

It is possible to apply only one of measures (I) to (III) given above to the porous material layer. The ranges within which the porosity, the tortuosity factor and the permeability of the porous material member can be controlled can be markedly widened in this case, too, compared with the case of using only one kind of the porous material member. As pointed out above, it is highly effective to apply each of measures (I) to (III) to the porous material layer.

### Third Embodiment

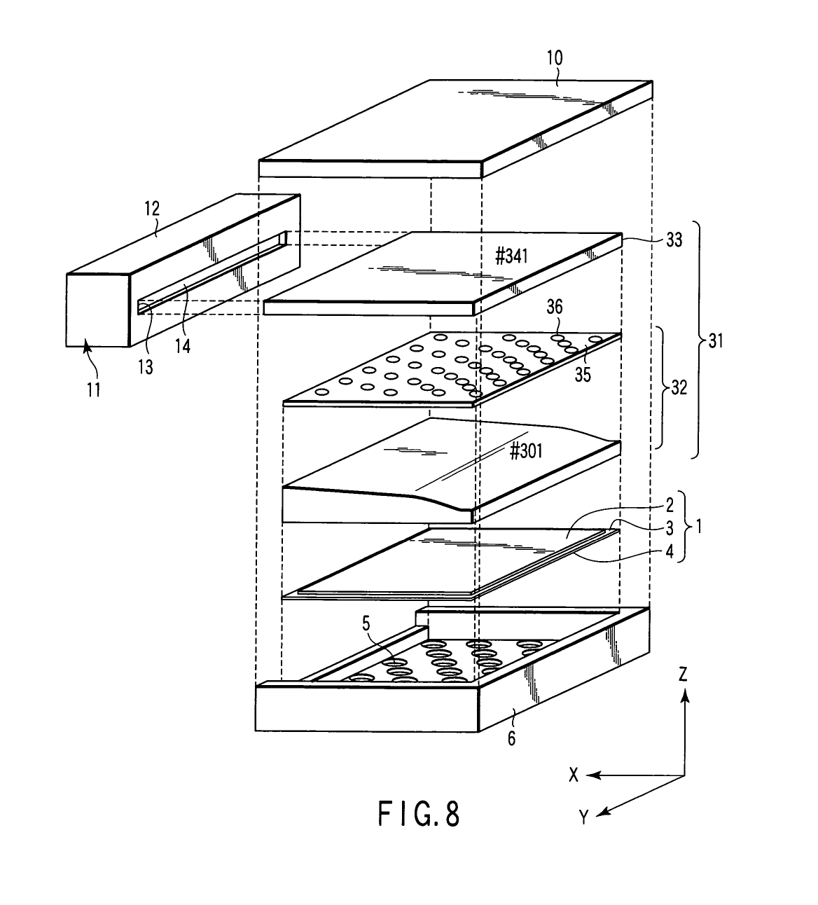

FIG. 8 is an oblique showing in a dismantled fashion the construction of a fuel cell according to the third embodiment of the present invention.

The same reference numerals are put to the members or the portions, which operate the same functions of the fuel cells shown in FIGS. 1 and 8, for omitting the detailed description thereof.

As shown in FIG. 8, a porous material layer 31 is formed on the MEA 1 on the side of the fuel electrode 2. The porous material layer 31 is a double-layer structure including of a first porous material layer 32 and a second porous material layer 33 stacked on the first porous material layer 32 in the Z-direction. The first porous material layer 32 is formed of a laminate prepared from stacking a composite 35 on a porous material member #301, and the second porous material layer 33 is formed of a single porous material member #341. A porous material member #301 that can be compressed is positioned right above the fuel cell 2, and the composite 35 is disposed right above the porous material member #301. Further, a porous material member #341 is positioned right above the composite 35. The fuel cell shown in FIG. 8 is equal in construction to the fuel cell shown in FIG. 1 except that the porous material layer 31 is constructed as described above. In other words, the fuel cell shown in FIG. 8 is equal in construction to the fuel cell shown in FIG. 1 in respect of, for example, the frame 6, the cover 10 and the fuel tank 11.

The features and effectiveness of the composite 35 that is newly introduced into the third embodiment will now be described.

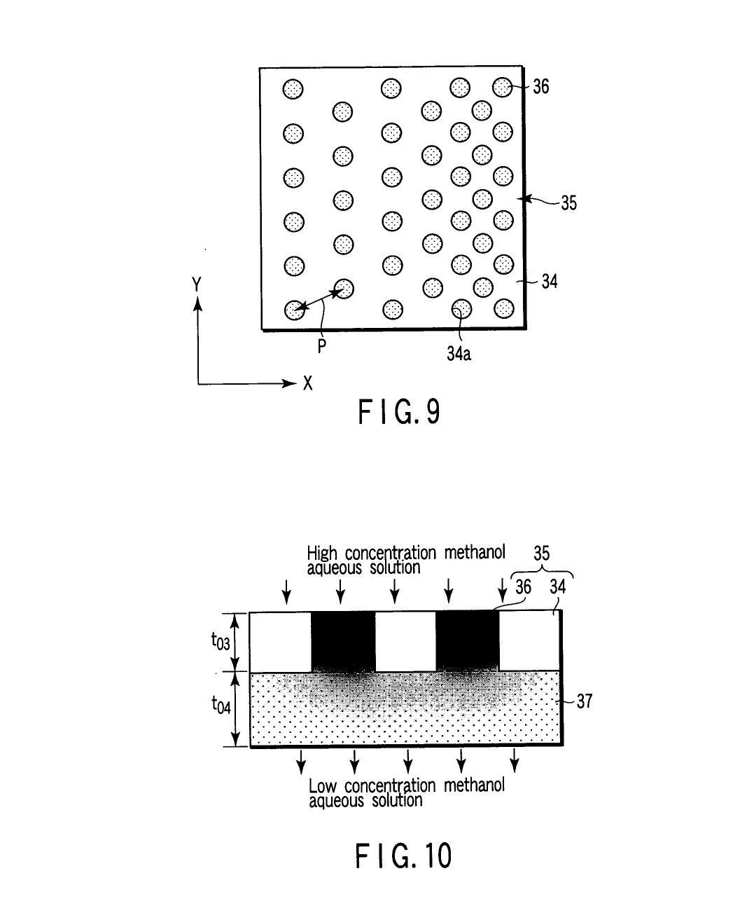

FIG. 9 is a plan view for explaining the composite 35 shown in FIG. 8. The composite 35 comprises a plate-like shielding member 34 provided with a plurality of through-holes 34a, i.e., 39 through-holes in FIGS. 8 and 9. Different porous material members 36, i.e., porous material members #302 to #340, are inserted into these through-holes 34a. The shielding member 34 inhibits the permeation of a methanol aqueous solution excluding the unintentional leakage and is not dissolved in a methanol aqueous solution so as to shield the methanol aqueous solution. The particular shielding member is formed of, for example, a polyimide plate.

FIG. 10 is a cross sectional view conceptually explaining the composite 35. Suppose the porous material members #302 to #340 have the same porosity ε₀₃. In other words, suppose that the same porous material members 36 are inserted into the through-holes of the shielding member 34 shown in FIG. 10. If the shielding member 34 has a true volume Vᵣ and the composite 35 has a volume Vₚ, the apparent porosity ε″ of the composite 35 can be calculated by formula (8) given below:
ε″=ε₀₃×(V_{P}−Vᵣ)/Vₚ (8)

Also, where the porous material members #302 to #340 have the permeability K₀₃, the apparent permeability K″ of the composite 35 can be calculated by formula (9) given below like the porosity ε″:
K″=K₀₃×(V_{P}−Vᵣ)/Vₚ (9)

The apparent tortuosity factor τ″ of the composite 35 can be calculated by measuring the diffusion coefficient D_{eff} in the case of including the composite 35 and by substituting the diffusion coefficient D_{eff} thus measured in formula (5) given previously. By using the particular composite, it is possible to obtain the concentration distribution and the pressure distribution similar to those in the case of using a single porous material member having the porosity ε″, the permeability K″, and the tortuosity factor τ″.

In the case of using the composite 35, as shown in FIG. 10, it is desirable to arrange a layer formed of a single porous material member 37 (corresponding to the porous material member #301 shown in FIG. 8) below the composite 35. The porous material member 37 moderates the nonuniform concentration and the nonuniform pressure that are generated right below the composite 35. In FIG. 10, the methanol concentration distribution is denoted by the gradation of the monochromatic color. The dilute color portion denotes the region having a low methanol concentration, and the dark color portion denotes the region having a high methanol concentration.

Also, as shown in FIG. 9, the open area of the through-holes per unit area of the shielding member is increased with increase in the distance of the site of the shielding member from the fuel supply port. It follows that it is possible to increase the ratio of the shielding member in the composite 35 on the side close to the fuel supply port (left side in FIG. 9) and to decrease the ratio of the shielding member with increase in the distance of the site of the shielding member from the fuel supply port in the X-direction. As a result, it is possible to make the porosity and the tortuosity factor low in the case where the distance from the fuel supply port is large. It follows that the combination of the porous material member #301 and the composite 35 produces the effect similar to that produced by the porous material members #101 to #112 in the first embodiment described previously. In other words, it is possible to realize a fuel cell having a high output and a high fuel utilization efficiency by combining the porous material member #301 and the composite 35, compared with the case where all the space occupied by the porous material member #301 and the composite 35 is occupied by the porous material member having the same porosity, the same tortuosity factor and the same permeability.

In the composite described above, it is possible to change the pitch p of the through-holes or the thickness t₀₃ of the composite and the thickness t₀₄ of the porous material member positioned right below the composite. As a result, the porosity ε″ can be freely changed within a range of ε₀₃ to ∞, the permeability K″ can be freely changed within a range of 0 to K₀₃, and the tortuosity factor τ″ can be freely changed within a range of 0 to τ₀₃. In this example, the porous material members #302 to #340 are formed of the same material. However, it is possible to use materials having different properties for forming the porous material members #302 to #340. It follows that the porosity ε″, the permeability K″ and the tortuosity factor τ″ can be controlled over a wider range.

In FIGS. 8 and 9, a desired porosity and a desired permeability are realized by changing the average pitch p of the through-holes in accordance with the distance of the site of the shielding member from the fuel supply port with the thickness of the shielding member set constant. It should also be noted, however, that it is impossible to control ε″ and K″ independently. Therefore, it is possible to utilize the properties obtained by compressing the porous material member in the third embodiment, too, as in the second embodiment. To reiterate, if a porous material member is compressed, the permeability K is greatly changed. On the other hand, in the case of compressing the porous material member, the amount of change of the porosity ε is smaller than that of the permeability K.

The porous material member #301 shown in FIG. 8 is positioned right below the composite 35 so as to moderate the nonuniform concentration and the nonuniform pressure. At the same time, the thickness of the porous material member #301 before the compression is changed in accordance with the region of the fuel electrode positioned below the porous material member #301. Particularly, in this case, the thickness of the porous material member #301 before the compression is changed in accordance with the distance of the site of the porous material member #301 from the fuel supply port. Pressure is applied to the porous material layer 31 by the cover 10. As a result, the amount of compression of the porous material member #301 can be changed in accordance with the region of the fuel electrode 2. It follows that, in the case of compressing the porous material member arranged right below the composite, it is desirable to use a rigid body for forming the shielding member.

It is possible to control mainly the apparent porosity by combining the porous material member #301 and the composite 35. Also, it is possible to control mainly the apparent permeability by compressing the porous material member #301. It follows that the apparent porosity ε″ and the apparent permeability K″ can be controlled independently. As a result, it is possible to supply the methanol aqueous solution to the catalyst layer of the fuel electrode under the state that each of the difference in concentration and the difference in pressure is small.

Incidentally, in the third embodiment, porous material members are inserted into a plurality of through-holes formed in the shielding member. Alternatively, it is also possible to form a plurality of through-holes in a porous material member and to insert the shielding member into these through-holes. The size, pitch and the number of through-holes are not limited to those shown in FIGS. 8 and 9. In FIG. 9, the ratio occupied by the shielding member is changed in accordance with the distance of the site of the shielding member from the fuel supply port. However, it is also possible to make constant the ratio occupied by the shielding member. In this case, for example, the porous material members #302 to #340 having sufficiently different properties each other are inserted into the through-holes so as to make it possible to obtain desired properties.

The shielding member described above can be regarded as a porous material member having a porosity ε of 0 and a permeability K of 0. In other words, it is possible to substitute a porous material member having an optional porosity, tortuosity factor and permeability for the shielding member. Even in this case, it is possible to obtain the effect similar to that obtained in the third embodiment.

### Fourth Embodiment

FIG. 11 is an oblique view showing in a dismantled fashion the construction of a fuel cell according to the fourth embodiment of the present invention.

The same reference numerals are put to the members and the portions, which operate the same functions of the fuel cells shown in FIGS. 1 and 11, for omitting the detailed description thereof.

As shown in FIG. 11, a porous material layer 41 is disposed on the MEA 1 on the side of the fuel electrode 2. The porous material layer 41 is of a double-layer structure consisting of a first porous material layer 42 and a second porous material layer 43 stacked on the first porous material layer 42 in the Z-direction. The first porous material layer 42 is formed of a single porous material member #401, and the second porous material layer 43 is also formed of a single porous material member #402. Cutouts are formed in the porous material member #402. Further, porous material members #401 and #402 are arranged right above the fuel electrode 2 in the order described above. The fuel cell shown in FIG. 11 is equal in construction to that shown in FIG. 1 except the porous material layer 41 is constructed as described above. In other words, the fuel cell shown in FIG. 11 is equal in construction to the fuel cell shown in FIG. 1 in respect of, for example, the frame 6, the cover 10 and the fuel tank 11.

The features and the effectiveness of the fourth embodiment will now be described in respect of mainly the porous material member #402 that is characteristic in this embodiment.

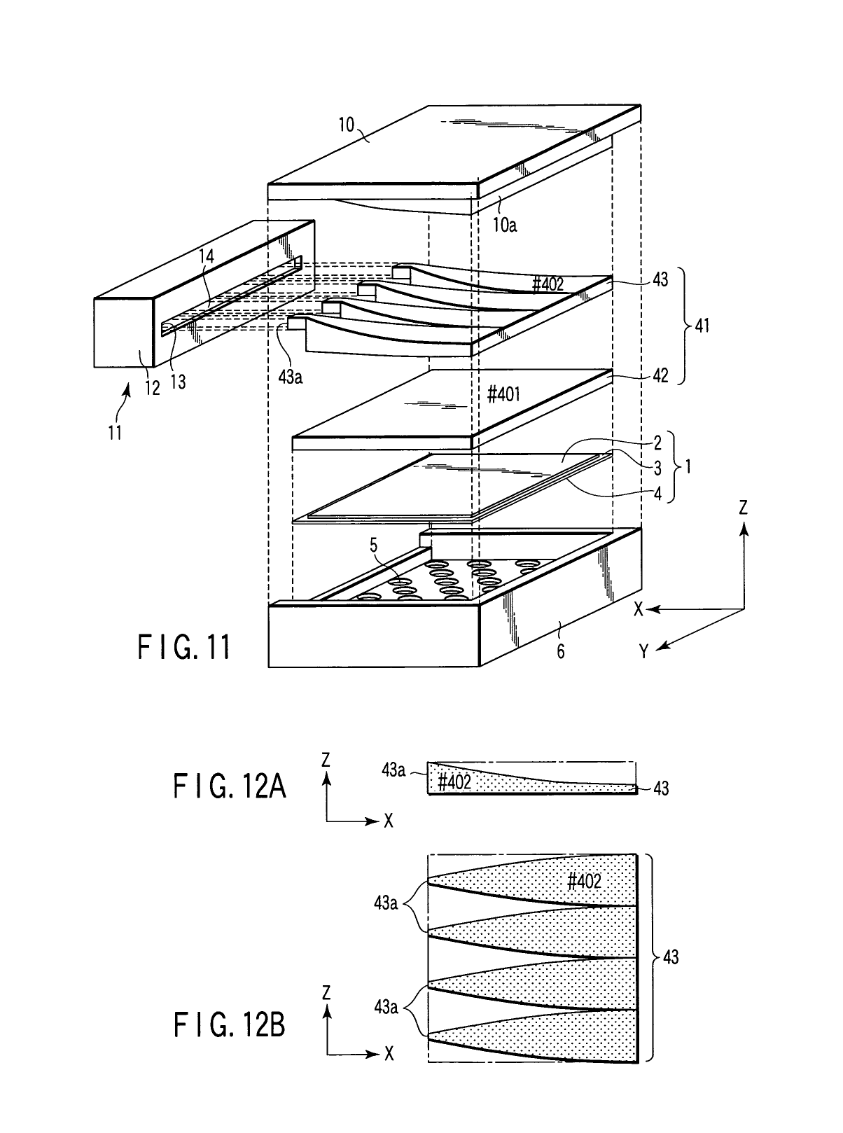

FIGS. 12A and 12B are a side view and a plan view, respectively, showing the construction of the second porous material layer shown in FIG. 11. As shown in FIG. 12, the contact area between the porous material member #402 and the porous material member #401 and the thickness of the porous material member #402 are changed in accordance with the region of the fuel electrode positioned below the porous material member #401. Particularly, in this embodiment, the contact area and the thickness noted above are changed in accordance with the distance of the site of the second porous material layer from the fuel supply port. As shown in FIG. 12A, the thickness of the porous material member #402 is gradually decreased with increase in the distance of the site of the porous material member #402 from the fuel supply port in the X-direction. Further, as shown in FIG. 12B, cutouts are formed in the porous material member #402. The cutout permits the contact area between the porous material member #402 and the porous material member #401 positioned below the porous material member #402 to be increased with increase in the distance of the site of the porous material member #402 from the fuel supply port in the X-direction. The cutout also diminishes the contact area between the porous material member #402 and the inside porous material member 14 within the fuel tank 11, i.e., the area of the fuel supply port 43a. In this case, the cover 10 is provided with a projection 10a that is engaged with the cutout of the porous material member #402.

The combination of the porous material member #401 and the porous material member #402 produces the effect similar to that produced by the composite 35 used in the third embodiment. It should be noted that the combination of the porous material member #401 and the porous material member #402 makes it possible to realize a fuel cell having a high output and a high fuel utilization efficiency, compared with the case where all the space occupied by the porous material member #401 and the porous material member #402 is occupied by a porous material member having the same porosity, the same tortuosity factor and the same permeability.

What should be noted is that, in the composite 35 in the third embodiment described previously, it is considered reasonable to understand that the porous material members are arranged discontinuously so as to change the contact area between the porous material members #302 to #340 and the porous material member #301 in accordance with the distance of the site of the composite 35 from the fuel supply port. In the fourth embodiment, however, it is considered reasonable to understand that the contact area between the porous material member #402 and the porous material member #401 is changed continuously in accordance with the distance of the site of the porous material member #402 from the fuel supply port, as shown in FIG. 11. By the combination of the porous material member #401 and the porous material member #402, it is possible to change the apparent porosity, the apparent tortuosity factor and the apparent permeability as in the third embodiment. In the fourth embodiment, the projection of the cover 10 performs the function similar to that performed by the shielding member in the third embodiment. In other words, the projection of the cover 10 serves to shield the permeation of the liquid fuel.

The porous material member #401 used in the fourth embodiment plays the roles played by the porous material member #341 having a constant thickness, which is shown in FIG. 8 relating to the third embodiment, and played by the porous material members #113 and #205, which are arranged in the similar positions in other embodiments. To be more specific, the porous material member #401 can moderate the nonuniformity of the concentration and the nonuniformity of the pressure that are generated right under the porous material member #402.

The description given above is directed to an example in which the second porous material layer 43 is formed of the porous material member #402, in which the thickness and the area of contact with another porous material member are changed in accordance with the distance of the site of the porous material member #402 from the fuel supply port. Alternatively, it is possible for the porous material member #402 to have a constant thickness. Where the thickness of the porous material member #402 is assumed to be constant, the cross sectional area of the fuel passageway is changed if the contact area between the porous material member #402 and the porous material member #401 is changed in accordance with the distance from the fuel supply port. It is possible to control the properties as described previously in conjunction with the second embodiment by changing not only the contact area between the porous material member #402 and the porous material member #401 but also, as required, the thickness of the porous material member #402. As a result, it is possible to make uniform the concentration and the pressure of the liquid fuel.

In the fourth embodiment, the cover 10 is provided with a projection 10a conforming with the cutout formed in the porous material member #402. The projection 10a of the cover 10 can be regarded as a porous material member having a porosity ε of 0, a tortuosity factor τ of ∞ and a permeability K of 0. In the fourth embodiment, it is possible to obtain an effect similar to that obtained in the case where a plurality of different kinds of porous material members are staked and the thickness of each of the porous material members is changed in accordance with the region of the fuel electrode positioned below the porous material members, as described previously in conjunction with the second embodiment.

As described above, the fourth embodiment, which employs the means described previously in conjunction with the first to third embodiments described previously, permits producing an effect similar to that produced by the first to third embodiments by using a smaller number of different kinds of the porous material members so as to suppress the difference in concentration and the difference in pressure of the liquid fuel supplied to the fuel electrode. In other words, it is possible to realize a fuel cell having a high output and a high fuel utilization efficiency, compared with the case of solely using the porous material members having the same porosity, the same tortuosity factor and the permeability and compared with the case of making uniform the contact area between a porous material member and another porous material member and between a porous material member and the fuel electrode as well as the thickness of the porous material member.

Incidentally, it is possible to combine in various fashions the porous material members used in the other embodiments. For example, it is possible to prepare a porous material layer by stacking the porous material member #202 shown in FIG. 5 or the composite 35 shown in FIG. 8 on the combination of the porous material members #101 to #112 shown in FIG. 1.

The embodiments described above are directed to a direct methanol fuel cell. However, the present invention is not limited to the direct methanol fuel cell. It is possible to apply the second to fourth embodiments like the first embodiment to all the fuel cells, in which a mixture of at least two kinds of liquid materials is used as the fuel, a porous material member is used for forming the transfer passageway of the fuel, and the fuel is supplied under the state of a liquid material.

As described above in detail, the present invention makes it possible to provide a fuel cell capable of obtaining a high output and a high fuel utilization efficiency.

Examples of the present invention will be described below.

### EXAMPLE 1

A porous material layer substantially equal in construction to the porous material layer 7 shown in FIG. 1 was prepared by using 13 kinds of the porous material members #101 to #113 having different properties.

The porous material member #113 had a porosity ε of 0.95 and a permeability K of 3.0×1.0⁻¹¹ m². The calculating region was defined as the catalyst layer of the fuel electrode, the diffusion layer of the fuel electrode and the porous material members #101 to #113 shown in FIG. 3. The conditions for supplying the fuel from the fuel tank and the consumed amounts of methanol and water in the MEA were given as the boundary conditions. The molar flux of methanol was set at a value corresponding to the value during the power generation of 0.15 A/cm², and the molar flux of water was set at 0. The concentration of the high concentration methanol aqueous solution filling the fuel tank was set at 99.99%. The tortuosity factor of each of the porous material members #101 to #113 was set at 1.5. The thickness in the Z-direction of each of the porous material members #101 to #112 was set at 1.0 mm. Further, the thickness of the porous material member #113 in the Z-direction was set at 1.5 mm.

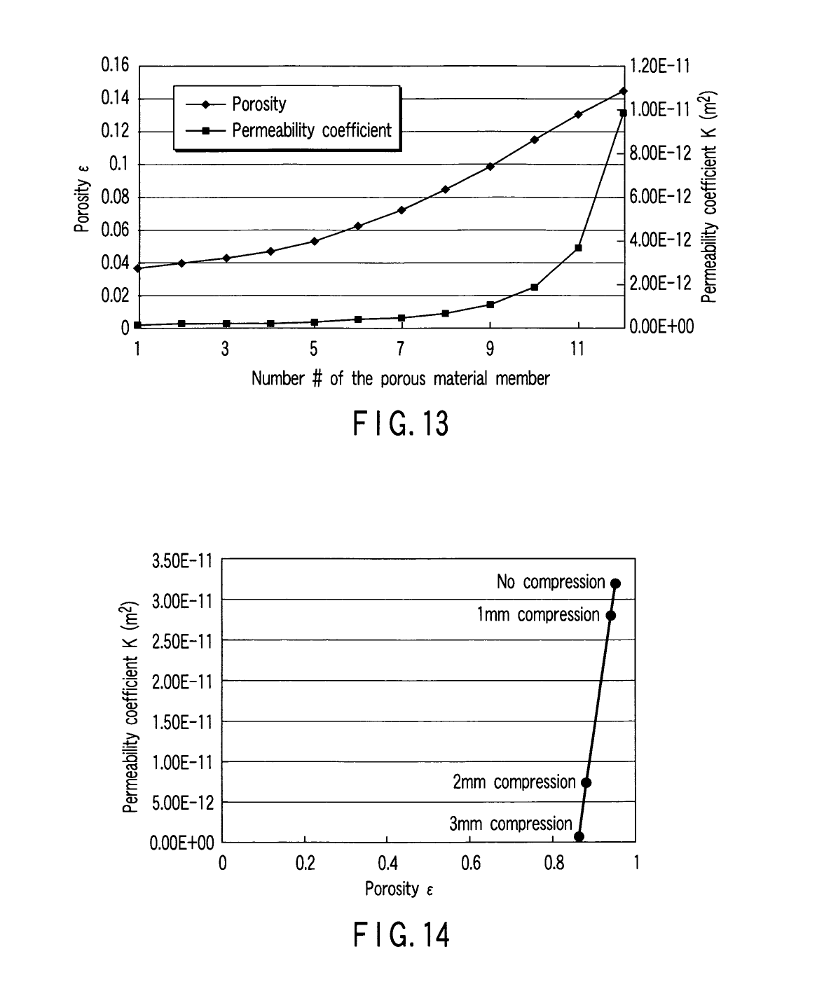

The porosity ε and the permeability K of each of the porous material members #101 to #112 were calculated by using CFD-ACE+ V2004 manufactured by CFD Research Corporation under the state that the methanol concentration and pressure of the fuel were made uniform on the surface of the diffusion layer of the fuel electrode. In this case, all of the mass conservation law, the momentum conservation law, and the chemical species conservation law of methanol and water are assumed to be satisfied. Also, the calculation was performed to permit the low concentration methanol aqueous solution supplied to the MEA to have a methanol concentration of 9.037%. This result was shown in FIG. 13.

As shown in FIG. 13, it has been indicated by calculation that it is possible to make uniform the methanol concentration of the methanol aqueous solution supplied to the fuel electrode by controlling the porosity ε and the permeability K of each of the porous material members #101 to #112 as denoted by the gradation of the monochromatic color of the concentration distribution shown in FIG. 3 so as to make it possible to supply a methanol aqueous solution having a substantially uniform methanol concentration to the anode catalyst layer.

### EXAMPLE 2

Prepared were the porous material member #01 having a porosity ε₀₁ of 0.9 and a thickness of t₀₁ and the porous material member #02 having a porosity ε₀₂ Of 0.1 and a thickness of t₀₂. Then, a porous material layer constructed as shown in FIG. 6 was prepared by stacking the porous material member #01 on the porous material member #02. The apparent porosity ε′ of the porous material layer was calculated as described previously by changing the thickness ratio (t₀₁/t₀₂) of the porous material member #01 to the porous material member #02. Table 1 shows the result.

TABLE 1

| Thickness ratio (t₀₁/t₀₂) | |
|---|---|
| of the porous material | |
| member #01 to the porous | |
| material member #02 | ε′ |
| 1/3 | 0.15 |
| 1 | 0.18 |
| 3 | 0.29 |

It has been indicated that it is possible to change the apparent porosity ε′ of the porous material layer within a range of between ε₀₁ and ε₀₂ by changing the ratio in thickness of the porous material member #01 to the porous material member #02. In this case, it has been confirmed that it is possible to lower the apparent porosity ε′ by increasing the thickness of the porous material member #02 formed of a porous material having a small porosity relative to the thickness of the porous material member #01.

### EXAMPLE 3

Prepared was a shielding member, and through-holes were formed in the shielding member in a manner to form a lattice. Then, a composite was obtained by inserting porous material members having a porosity of 0.9 and a permeability of 4.5×10⁻¹¹ m² into the through-holes. The volume ratio (Vₚ:Vₐ) of the volume Vₚ of the composite to the volume Vₐ of the shielding member was set at 11:3. A porous material layer constructed as shown in FIG. 10 was obtained by stacking the composite on a porous material member that was substantially equal in properties to the porous material member inserted in the shielding member of the composite.

The porosity ε and the permeability K of the porous material layer were calculated as in Example 1. In this calculation, the tortuosity factor τ was left unchanged.

As a result, it has been indicated by the calculation that, in the porous material layer thus obtained, it is possible to obtain the pressure distribution and the concentration distribution corresponding to those of a porous material layer formed of a single material, which is formed of a porous material member having the permeability K″ of 2.23×10⁻¹¹ m² and the porosity ε″ of 0.56. In this case, the concentration distribution of the methanol aqueous solution was as indicated by the gradation of the monochromatic color shown in FIG. 10. It has been indicated by the calculation that, when it comes to a porous material layer comprising the composite and a single porous material member formed below the composite and intended to moderate the nonuniformity of the concentration and the nonuniformity of the pressure, it is possible to obtain the concentration distribution and the pressure distribution substantially equal to those in the case where the region of the porous material layer is apparently formed of a uniform porous material member having the porosity ε″ and the permeability K″.

### EXAMPLE 4

A cellulose sponge manufactured by Toray Fine Chemical Inc. was prepared as a porous material member having a thickness h of 4 mm. The porous material member was compressed in the Z-direction in three stages such that the Δh was set at 1 mm, 2 mm and 3 mm, as shown in FIG. 7. The porosity ε in this case was calculated by formula (3) given previously, and the permeability K (m²) was calculated by formula (6) given previously. FIG. 14 shows the result. In this case, the tortuosity factor was assumed not to be changed because the compression ratio was small.

As shown in FIG. 14, the permeability was greatly changed by the compression of the porous material member. On the other hand, the porosity was also changed by the compression of the porous material member, though the changing amount of the porosity was smaller than that of the permeability.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel cell, comprising:
a fuel electrode;
an oxidant electrode;
a fuel supply port; and
a porous material layer for transferring a liquid fuel from the fuel supply port to the fuel electrode;
wherein the porous material layer has different values of at least one of a porosity, a permeability and a tortuosity factor depending on the distance of a site of the porous material layer from at least one of the fuel supply port and the fuel electrode.

2. The fuel cell according to claim 1, wherein the porous material layer includes a plurality of porous material members, and at least one of the porous material members is arranged in contact with the fuel electrode; and
the farther from the fuel supply port, the higher value of at least one of the porosity and the permeability of the porous material member in contact with the fuel electrode or the lower value of the tortuosity factor of the porous material member in contact with the fuel electrode.

3. The fuel cell according to claim 1, wherein the porous material layer contains particles having a diameter d, and the relationship between the diameter d of the particle and at least one of the porosity and the permeability of the porous material layer satisfies formula (1) given below:
$$d = C \times \sqrt{\frac{{K ( 1 - ɛ )}^{2}}{{ɛ}^{3}}} \qquad ( 1 )$$
where d denotes the particle diameter, ε denotes the porosity, K denotes the permeability, and C denotes a proportional constant falling within a range of between the proportional constant of Carman-Kozeny formula and the proportional constant of Blake-Kozeny formula including the proportional constant of Carman-Kozeny formula and the proportional constant of Blake-Kozeny formula.

4. The fuel cell according to claim 1, wherein the porous material layer includes a laminate prepared by stacking a plurality of porous material members, at least one of the porous material members having different values of at least one of the porosity, the permeability and the tortuosity factor from the other porous material members, and having the thickness to be gradually increased or decreased depending on the distance from the fuel supply port.

5. The fuel cell according to claim 1, wherein the porous material layer includes a plurality of porous material members, and the thickness of at least one of the porous material members is gradually decreased with increase in the distance from the fuel supply port.

6. The fuel cell according to claim 1, wherein the porous material layer includes a laminate prepared by stacking a first porous material member having the thickness gradually increased with increase in the distance from the fuel supply port, and a second porous material member smaller than the first porous material member in at least one of the porosity and the permeability, and having the thickness gradually decreased with increase in the distance of a site of the second porous material member from the fuel supply port.

7. The fuel cell according to claim 1, wherein the porous material layer includes a plurality of porous material members differing from each other in at least one of the porosity, the permeability and the tortuosity factor, and these porous material members are arranged along the fuel electrode in the order of the value of the porosity, the permeability or the tortuosity factor such that, the farther from the fuel supply port, the higher value of at least one of the porosity and the permeability of the porous material member in contact with the fuel electrode or the lower value of the tortuosity factor of the porous material member in contact with the fuel electrode.

8. The fuel cell according to claim 1, wherein the porous material layer includes a plurality of porous material members, and the contact area of at least one of the porous material members with the adjacent porous material member is increased with increase in the distance of a site of the porous material layer from the fuel supply port.

9. The fuel cell according to claim 1, wherein the porous material layer includes a plurality of porous material members and at least one shielding member, and the shielding member is arranged between the porous material members such that the area of the surface of at least one of the porous material members on the side of the fuel electrode is gradually increased with increase in the distance from the fuel supply port.

10. The fuel cell according to claim 1, wherein the porous material layer includes a plurality of porous material members and at least one shielding member, and the porous material members are inserted into through-holes open in the shielding member such that the open area per unit area of the porous material layer is increased with increase in the distance of a site of the shielding member from the fuel supply port.

11. The fuel cell according to claim 1, wherein the porous material layer includes a plurality of porous material members and a plurality of shielding members, and the shielding members are inserted into through-holes open in the porous material member such that the open area per unit area of the porous material layer is decreased with increase in the distance of a site of the porous material member from the fuel supply port.

12. The fuel cell according to claim 1, wherein the porous material layer is compressed at least partially.

13. The fuel cell according to claim 1, wherein the porous material layer includes a porous material member that is compressed such that the compression ratio is decreased with increase in the distance from the fuel supply port.

14. The fuel cell according to claim 1, wherein the porous material layer includes a porous material member having a tortuosity factor of 1.

15. A fuel cell, comprising:
a fuel electrode;
an oxidant electrode;
a fuel supply port; and
first and second porous material layers for transferring a liquid fuel from the fuel supply port to the fuel electrode;
wherein:
the first porous material layer has different values of at least one of a porosity, a permeability and a tortuosity factor depending on the distance of a site of the first porous material layer from at least one of the fuel supply port and the fuel electrode; and
the second porous material layer is formed of a single porous material member.

16. The fuel cell according to claim 15, wherein the first porous material layer is arranged in contact with the fuel electrode.

17. The fuel cell according to claim 15, wherein the first porous material layer includes a plurality of porous material members differing from each other in at least one of the porosity, the permeability and the tortuosity factor, and these porous material members are arranged along the fuel electrode in the order of the value of the porosity, the permeability or the tortuosity factor such that, the farther from the fuel supply port, the higher value of at least one of the porosity and the permeability of the porous material member in contact with the fuel electrode or the lower value of the tortuosity factor of the porous material member in contact with the fuel electrode.

18. The fuel cell according to claim 15, wherein the first porous material layer includes a laminate prepared by stacking a first porous material member having the thickness gradually increased with increase in the distance from the fuel supply port, and a second porous material member smaller than the than the first porous material member in at least one of the porosity and the permeability, and having the thickness gradually decreased with increase in the distance of a site of the second porous material member from the fuel supply port.

19. The fuel cell according to claim 15, wherein the first material layer includes a shielding member, porous material members inserted into through-holes open in the shielding member such that the open area per unit area of the first porous material layer is increased with increase in the distance from the fuel supply port, and a compressed porous material member that is compressed such that the compression ratio is decreased with increase in the distance from the fuel supply port.

20. A fuel cell, comprising:
a fuel electrode;
an oxidant electrode;
a fuel supply port; and
first and second porous material layers for transferring a liquid fuel from the fuel supply port to the fuel electrode;
wherein:
the first porous material layer is formed of a single porous material member; and
the second porous material layer includes a plurality of porous material members, and the contact area of at least one of the porous material members with the first porous material layer is increased with increase in the distance of a site of the second porous material layer from the fuel supply port.
